(19) United States
(12) Patent Application Publication
(10) Pub. No.: US 2015/0143911 A1
(43) Pub. Date: May 28, 2015

(54) PHYSICAL/CHEMICAL SENSOR AND METHOD FOR MEASURING SPECIFIC SUBSTANCE

(71) Applicants: National University Corporation, Toyohashi-shi (JP); STANLEY ELECTRIC CO., LTD., Tokyo (JP)

(72) Inventors: Kazuhiro TAKAHASHI, Toyohashi-shi (JP); Chiharu SASAKI, Tokyo (JP); Masanao TANI, Tokyo (JP); Takaaki KOYAMA, Tokyo (JP)

(73) Assignees: STANLEY ELECTRIC CO., LTD., Tokyo (JP); National University Corporation, Toyohashi-shi (JP)

(21) Appl. No.: 14/549,371

(22) Filed: Nov. 20, 2014

(30) Foreign Application Priority Data
Nov. 22, 2013 (JP) 2013-242093

(51) Int. Cl. G01N 21/17; G01N 29/12

(52) U.S. Cl. CPC G01N 21/1702; G01N 29/12; G01N 2021/1708; G01N 2201/06113; G01N 2291/02809; G01N 2291/023; G01N 2291/014
USPC 73/643

(57) ABSTRACT

[Problems to be solved]

A physical/chemical sensor that enables reduction of the size of the sensor and formation of arrays of the sensors is provided. The sensor can sense small change of surface stress and can measure mass of fixed specific substance. Also, a measuring method of the specific substance using the sensor is provided.

[Means for solving problems]

A physical/chemical sensor has a movable membrane (3) having a diaphragm structure provided to form a hollow section (2) between the movable membrane (3) and a light receiving surface of a light receiving element (1), a first piezoelectric membrane (4) that is provided on a front-side surface or a backside surface of the movable membrane (3) and that excites the movable membrane (3), and a second piezoelectric membrane (5) that is provided on the front-side surface or the backside surface of the movable membrane (3) and that senses a voltage caused by oscillation of the movable membrane (3). A measuring method using the physical/chemical sensor applies a voltage to the first piezoelectric membrane (4) while changing frequency and senses resonance frequency by sensing a voltage outputted from the second piezoelectric membrane (5).

### TECHNOLOGICAL FIELD

The present invention relates to a physical/chemical sensor and specifically relates to a sensor for measuring a fixation state and mass of molecules of label-free specific substance and to a measuring method of the specific substance using the sensor.

### BACKGROUND TECHNOLOGY

In recent years, as represented by a fuel cell, technologies using hydrogen gas as an energy source have been developed and are spreading. In connection with this, sensors for detecting the hydrogen gas are emphasized. It is considered to be important to detect emission of gases (for instance, carbon dioxide or nitrogen dioxide), which can induce environment pollution, for environmental protection. Detection of gases containing components used for explosives (for instance, trinitrotoluene: TNT, trimethylenetrinitramine: RDX, or the like) is useful for discovering a mine. Furthermore, in medical sites, in order to determine whether a patient is suffering a specific disease by detecting an antibody of a specific kind or an antigen of a specific kind, a sensor for detecting a specific protein that forms the antibody or antigen is emphasized.

Therefore, in the medical sites, as a method for specifying protein of a specific kind, fluorescent label technology using a fluorescence label has been used. This technology causes an activated fluorescent group to react with protein, thereby using it as a label. Multiple kinds of protein can be detected at the same time, and handling of the fluorescent dye is easy. Therefore, the technology has been used widely. However, with this fluorescent label technology, there has been a concern that the protein structure could be degraded due to reaction with the fluorescent group. Moreover, there has been a problem about quantitative evaluation that location of the fluorescent group modification and control of the number of the labels are difficult.

As a measure for solving the above-mentioned problems, a sensor that does not use a label, or a label-free sensor, is proposed. That is, an antibody molecule that causes specific adsorption to a specific acceptor is fixed on the sensor, and change in physical quantity (mass, reflactive index, intermolecular force) caused by the adhesion of target protein is sensed. As prior art examples of such sensors, a sensor that uses a character that resonance frequency fluctuates with change of mass due to the adhesion of the protein (Quarts Crystal Microbalance: QCM) and a sensor that uses change of the reflactive index by surface plasmon resonance (Surface Plasmon Resonance: SPR) are known.

Therefore, part of the inventors of the present invention developed a technology for forming a Fabry-Perot resonator with a membrane section, which is made of a material having an ability to fix specific substance, and a surface of a light receiving element and for sensing a fixation state of the specific substance based on change in intensity of transmitted light having specific wavelength (refer to Patent document 1). According to the technology, the membrane section having the substance fixation ability fixes the specific substance and the membrane section bends due to an intermolecular force of the substance. The intensity of the transmitted light having the specific wavelength changes in accordance with the degree of the bending. The specific substance can be detected by sensing the change of the intensity. By replacing the material of the membrane section with a certain material, a molecule that can be fixed by a fixation ability of the certain material can be detected. Mass of the molecule can be estimated based on the bending state of the membrane section. However, since the membrane section does not change linearly, the above technology cannot measure the mass of the molecule correctly so far.

A sensor element for measuring the mass of the molecule adhering (or adsorbed) to the above-mentioned sensor can cause resonant drive of a cantilever and can quantify the mass of the adsorbed molecule from frequency change of an oscillator. In this case, the oscillator can be manufactured to be small as compared to the above-mentioned QCM sensor, and improvement of mass sensitivity can be expected. Generally, the mass sensitivity is determined by thickness and density of the oscillator in the sensor using the oscillation. Therefore, the mass sensitivity can be improved by reducing the size of the oscillator.

As examples of a sensor that uses a small cantilever (micro-cantilever) or the like and senses frequency of oscillation of the cantilever, there have been a sensor that uses optical methodology using a laser Doppler displacement meter (refer to Non-patent document 1) and a sensor that uses a methodology of determining change of capacitance (refer to Non-patent document 2). However, in the case of the sensor using the optical methodology, an analyzer is necessary and it is difficult to reduce the size of the entire body of the measuring device. In the case of the sensor using the capacitance, the change of the capacitance is small and a parasitic component is large. Therefore, increase of the area of the capacitor is necessary, and there has been a problem in the reduction of the size of the element.

In addition to these methodologies, a methodology of outputting oscillation of a membrane in the form of a voltage using a piezoelectric membrane is proposed (refer to Non-patent documents 3 and 4). It is reported that, with this methodology, power consumption is small, and movement of a micro-structure caused by the oscillation can be outputted in the form of the voltage with a small element.

### PRIOR ART DOCUMENT

### Patent Document

[Patent document 1] WO2013/047799

### Non-Patent Document

[Non-patent document 1]K. S. Hwang, J. H. Lee, J. Parl, D. S. Yoon, J. H. Park, T. S. Kim, “In-situ quantitative analysis of a prostate-specific antigen (PSA) using a nanomechanical PZT cantilever,” Lab Chip 4 pp. 547-552, 2004.
[Non-patent document 2] K. K. Park, H. Lee, M. Kupnik, O. Oralkan, J. P. Ramseyer, H. P. Lang, M. Hegner. C. Gerber, and B. T. Khuri-Yakub, “Capacitive micromachined ultrasonic transducer (CMUT) as a chemical sensor for DMMP detection,” Sensors and Actuators B, pp. 1120-1127, 2011.
[Non-patent document 3] D. M. Karabacak, S. H. Brongersma, and M. Crego-Calama, “Enhanced sensitivity volatile detection with low power integrated micromechanical resonators,” Lab Chip, vol. 10, pp. 1976-1982, 2010.
[Non-patent document 4] J. Pettine, M. Patrascu, D. M. Karabacak, M. Vandecasteele, V. Petrescu, S. H. Brongersma, M. Crego-Calama, and C. Van Hoof, “Volatile detection system using piezoelectric micromechanical resonators interfaced by an oscillator readout,” Sensors and Actuators A, pp. 496-503-2013.

### SUMMARY OF THE INVENTION

### Problems to be Solved by the Invention

The technology described in Patent document 1 has high performance as a label-free sensor among the conventional technologies mentioned above. However, it has a problem in accuracy of mass measurement of molecules. Among the technologies that perform resonant drive of the cantilever and quantify the mass of the adsorbed molecule from the frequency change of the oscillator, only the technology of outputting the oscillation of the membrane in the form of the voltage using the piezoelectric membrane possibly can output the oscillation in the form of the voltage using the small element. However, there is a concern that specific substance adsorbs to a backside surface if the cantilever is used. Also, an influence of the adsorption on the measurement value has been considered to be a problem. As a result, the technology has not yet been put in practical use as a label-free sensor for the specific substance. Therefore, a small sensor and a measurement method capable of performing detection and mass measurement of specific substance such as specific protein without using a label have been desired.

The present invention was made in consideration of the above and has an object to provide a physical/chemical sensor that enables reduction of the size of the sensor and formation of arrays of the sensors, the sensor being able to sense small change of surface stress and to measure mass of fixed specific substance. The present invention also has an object to provide a measuring method of the specific substance using the sensor.

### Means for Solving Problems

According to an aspect of the present invention, a physical/chemical sensor has a movable membrane, a first piezoelectric membrane and a second piezoelectric membrane. The movable membrane has a diaphragm structure provided to form a hollow section between the movable membrane and a light receiving surface of a light receiving element. The first piezoelectric membrane is provided on a front-side surface or a backside surface of the movable membrane and excites the movable membrane. The second piezoelectric membrane is provided on the front-side surface or the backside surface of the movable membrane and senses a voltage caused by oscillation of the movable membrane. The movable membrane has a substance fixation ability at least on an outside surface thereof and forms a Fabry-Perot resonator with the light receiving surface.

With the above construction, the movable membrane constitutes the Fabry-Perot resonator with the light receiving surface of the light receiving element and can oscillate when excited by the first piezoelectric membrane. That is, the bending state of the movable membrane can be outputted electrically by sensing the intensity of the light transmitted through the movable membrane. At the same time, the movable membrane can be excited with the first piezoelectric membrane, and the oscillating state of the movable membrane can be outputted electrically with the second piezoelectric membrane. Thus, the intermolecular force of the substance fixed by the substance fixation ability of the movable membrane can be measured and the mass of the molecule can be measured. More specifically, the movable membrane bends due to the action of the intermolecular force if the molecule is fixed to the movable membrane. Accordingly, the intensity of the transmitted light changes in conjunction with the bending. Therefore, existence of the specific substance can be detected from the measurement result of the intensity. The resonance frequency at the time when the movable membrane is excited changes according to the quantity of the fixed molecule. Therefore, the quantity (mass) of the fixed molecule can be grasped by exciting the movable membrane fixing the molecule and by sensing the resonance frequency of the movable membrane. By sensing both of the mass and the intermolecular force, the case where the intermolecular force differs although the mass is the same can be detected. Thus, the change of the structure of the fixed substance can be also detected.

Furthermore, change of the transmitted light in the state where the movable membrane is excited to oscillate can be sensed as a photocurrent. Therefore, the oscillating state of the movable membrane can be sensed form the change of the transmitted light. Thus, the change of the voltage sensed with the second piezoelectric membrane (detection electrode) provided to the movable membrane and the change of the intensity of the transmitted light can be measured simultaneously. Thus, a mechanical resonance point of the movable membrane can be specified by sensing the amplitude while checking the oscillation of the movable membrane.

According to another aspect of the present invention, in the above construction, the hollow section may have an opening in a predetermined area that faces the light receiving surface of the light receiving element. The movable membrane may be formed to block the opening of the hollow section.

In this case, the hollow section can be blocked with the movable membrane liquid-tightly or air-tightly. Therefore, adsorption of the gas or the liquid as the test object (hereafter, referred to also as specimen) to the backside surface of the movable membrane due to permeation of the specimen to the hollow section and the like can be avoided.

According to another aspect of the present invention, in the above construction, the opening of the hollow section may have a substantially round shape. The movable membrane may block the opening of the hollow section and may be formed as a diaphragm structure in a substantially round shape. The first and second piezoelectric membranes may be formed in the shape of substantially annular belts coaxial around the center of the movable membrane. The first and second piezoelectric membranes may be arranged on the center side of an edge of the opening of the hollow section. The substantially annular shape includes not only a perfect round ring-like shape but also a round ring-like shape that can be considered to have a circular shape. The substantially annular shape includes a continuous annular shape and a discontinuous annular shape having a cut portion.

In the case of such the construction, since the first piezoelectric membrane is formed in the shape of the substantially annular shape, the entire body of the movable membrane can be excited from the circumference of the movable membrane. Accordingly, the oscillating state of the movable membrane due to the excitation can be stabilized. Moreover, since the second piezoelectric membrane is also formed in the substantially annular shape, the state of the oscillation of the movable membrane can be sensed from the entire circumference of the movable membrane.

According to another aspect of the present invention, in the above construction, the first and second piezoelectric membranes may be arranged only on either the front-side surface or the backside surface of the movable membrane. The second piezoelectric membrane may be arranged to be nearer to the center of the movable membrane than the first piezoelectric membrane is such that a gap is formed between the first and second piezoelectric membranes.

In the case of such the construction, both of the first and second piezoelectric membranes are formed on either the front-side surface or the backside surface of the movable membrane. Therefore, the excitation and the sensing are performed under the similar conditions. The second piezoelectric membrane is located on the center side of the first piezoelectric membrane. Therefore, the oscillating state can be sensed in the position where the amplitude of the movable membrane is larger than in the position of the excitation. Accordingly, the oscillating state of the movable membrane can be sensed surely.

According to another aspect of the present invention, in the above construction, the movable membrane may be made of a material that has a molecule fixation ability to fix molecules contained in a gas or a liquid.

With the above construction, specific gases (for instance, flammable gas or gas that can affect environment), biopolymers and the like can be measured. Hydrogen gas and gases contained in explosives such as TNT or RDX can be taken as examples of the flammable gas. Carbon dioxide and nitrogen dioxide can be taken as examples of the gases that can affect the environment. Polymers containing amino acid, nucleic acid or polysaccharide (for instance, antibody, deoxyribonucleic acid (DNA), ribonucleic acid (RNA) and the like) can be taken as examples of the biopolymer. When the molecule fixation ability includes an antibody fixation ability for fixing the antibody, the antibody may be fixed to the surface of the movable membrane beforehand, and a state of binding of specific protein (antigen), which binds to the antibody, to the antibody can be also detected and measured.

According to another aspect of the present invention, in the above construction, the movable membrane may have a flexible base membrane and have a molecule fixation membrane, which is formed by laminating a material having a molecule fixation ability on a surface of the base membrane.

In the case of the above construction, molecule fixation membranes of different kinds may be laminated to constitute various kinds of sensors according to object substance to be detected and measured. For instance, parylene A and parylene AM for fixing the antibody can be taken as examples of the molecule fixation membrane. Parylene is a general term for paraxylene series polymers and has a structure in which benzene rings are connected through CH₂. Parylene A has an amino group in the side chain. Parylene AM has a structure, in which a methyl group and an amino group are combined in series in the side chain. Therefore, the antibody can be combined with the amino group.

When the multiple layers are laminated in the movable membrane as mentioned above, a metal film may be laminated at the same time such that the metal film functions as a half mirror. By constituting the half mirror, selectivity of the wavelength that causes interference inside the Fabry-Perot resonator can be improved. In this case, a metal film may be laminated also on the light receiving surface of the light receiving element. Thus, half width of interference wavelength can be narrowed.

According to another aspect of the present invention, in the above construction, the first and second piezoelectric membranes may be made of lead zirconate titanate (PZT).

With the above construction, due to reaction sensitivity of PZT as the piezoelectric element, reactivity at the time of exciting the movable membrane while changing the frequency is stabilized. Moreover, sensing accuracy of the oscillation of the movable membrane is improved, thereby improving reliability of detection of the resonance point.

According to another aspect of the present invention, in the above construction, the surface of the movable membrane may be uneven.

In this case, the surface area of the movable membrane increases, and therefore the absolute quantity of the fixed specific substance (molecule) can be increased. As the construction that the surface is uneven, for instance, a construction that recesses are formed on the front-side surface of the movable membrane at suitable intervals can be taken as an example. Alternatively, the front-side surface may be finished not to be smooth intentionally.

According to another aspect of the present invention, a measuring method of specific substance using the above physical/chemical sensor has the steps of changing frequency of a voltage applied to the first piezoelectric membrane to change frequency of oscillation of the movable membrane, sensing resonance frequency at the time of the oscillation of the movable membrane based on a voltage outputted from the second piezoelectric membrane, and converting a change amount of the resonance frequency into mass of the specific substance fixed to the movable membrane.

With the above construction, the movable membrane is excited with the first piezoelectric membrane, and the state of the oscillation is electrically outputted with the second piezoelectric membrane. The oscillation shows the largest amplitude at the resonance point. Therefore, the resonance point of the oscillation of the movable membrane can be detected based on the magnitude of the voltage outputted from the second piezoelectric membrane. The oscillation of the movable membrane differs between the case where the specific substance is fixed to the surface of the movable membrane and the case where the specific substance is not fixed to the surface of the movable membrane. That is, when the specific substance is fixed by the substance fixation ability of the surface of the movable membrane, the mass of the fixed specific substance acts on the movable membrane as a load, and the oscillation of the movable membrane slows down, and the mechanical resonance point changes. Therefore, the mass of the fixed specific substance can be sensed according to the change of the resonance point. The change of the intensity of the light transmitted through the movable membrane can be sensed by sensing the photocurrent in the light receiving element at the same time. Therefore, the intermolecular force can be also measured simultaneously. At this time, when measuring the intermolecular force, the oscillation of the movable membrane is not requisite. The measurement of the intermolecular force can be performed even if the movable membrane does not oscillate. The state of the oscillation of the movable membrane can be also grasped by measuring the photocurrent while the movable membrane oscillates.

According to another aspect of the present invention, a measuring method of specific substance using the above physical/chemical sensor has the steps of forming a plurality of the physical/chemical sensors under the same conditions, classifying the physical/chemical sensors into at least one detection sensor and at least one reference sensor, supplying gaseous specimen or liquid specimen containing certain substance as a measurement object only to the at least one detection sensor, wherein the movable membrane has the fixation ability to fix the certain substance, changing frequency of a voltage applied to the first piezoelectric membranes of the at least one detection sensor and the at least one reference sensor to change frequencies of oscillation of the movable membranes simultaneously, sensing resonance frequencies at the time of the oscillation of the movable membranes based on voltages outputted from the second piezoelectric membranes, and comparing the resonance frequencies of the at least one detection sensor and the at least one reference sensor to convert a difference between the resonance frequencies into mass of the specific substance.

In the above construction, the multiple physical/chemical sensors are classified into the detection sensor and the reference sensor. Therefore, by supplying the specimen only to the detection sensor, difference in the resonance frequency of the movable membrane between the case where the specific substance is fixed and the case where the specific substance is not fixed can be sensed immediately. That is, the detection sensor and the reference sensor are operated simultaneously and both resonance frequencies are sensed. Thus, it is clarified that the difference is caused by the fixation of the specific substance. Therefore, the mass of the fixed specific substance can be grasped from the difference. Conversion between the mass of the fixed substance and the resonance frequency can be performed more easily by using calibration curves obtained by experimental statistics. The first and second piezoelectric membranes are laminated on the surface of the movable membrane that oscillates. If the first and second piezoelectric membranes are formed under different conditions, difference can occur between the resonance frequencies of the movable membranes. In order to avoid the occurrence of the difference in the resonance frequency, the reference sensor is formed under the same conditions as the detection sensor. When the liquid specimen is supplied as the specimen, it is assumed that the oscillation changes slightly due to the weight of the liquid, the surface tension of the liquid and the like. Therefore, the same quantity of a liquid, which does not contain the specific substance, as the liquid specimen may be supplied to the reference sensor and the output of the reference sensor may be compared with the output of the detection sensor.

According to yet another aspect of the present invention, the above measuring method of the specific substance may further have the steps of illuminating the light receiving surface of the light receiving element with light in a state where a voltage is applied to the first piezoelectric membrane, measuring change of intensity of transmitted light having specific wavelength as a photocurrent, and estimating the resonance frequency at the time of the oscillation of the movable membrane according to the change of the intensity of the transmitted light.

In the case of the above construction, in addition to the oscillating state of the movable membrane sensed from the second piezoelectric membrane, the change of the intensity of the transmitted light, which changes with the oscillation of the movable membrane, can be sensed. By measuring the photocurrent, the state of the oscillation of the movable membrane can be grasped and it can be determined that the output from the second piezoelectric membrane is caused by the oscillation of the movable membrane.

### Effects of the Invention

According to the present invention concerning the physical/chemical sensor, the movable membrane as the constituent part of the present invention functions as the movable membrane that oscillates due to the excitation and that constitutes a part of the Fabry-Perot resonator. Therefore, the mass measurement with the piezoelectric method is enabled while maintaining the effects of the sensor using the Fabry-Perot resonator. That is, existence of the substance fixed to the surface of the movable membrane can be determined based on the change of the intensity of the light transmitted through the movable membrane. In addition, by exciting the movable membrane and detecting the resonance point of the movable membrane oscillating in conjunction with the excitation, the mass of the fixed substance can be measured. These sensors can be manufactured to be very small by using the semiconductor process. The sensors can be integrated by forming the sensors on a semiconductor chip.

The movable membrane is formed to constitute the hollow section for the Fabry-Perot resonator. Therefore, only the front-side surface of the movable membrane is exposed outside the sensor. The backside surface of the movable membrane is arranged to face the light receiving surface of the light receiving element across the hollow section. Thus, the adsorption of the specific substance, which is contained in the specimen, to the backside of the movable membrane can be avoided. Thus, concern about the influence on the measurement value can be removed. Since the specific substance is not adsorbed to the backside of the movable membrane, treatment for preventing the adsorption to the backside of the movable membrane is unnecessary. As a result, increase of the number and complexity of the processes of the manufacture can be avoided.

According to the present invention concerning the measuring method of the specific substance, both of the change of the intensity of the light transmitted through the movable membrane and the amplitude during the oscillation can be outputted electrically. Therefore, these sensed values can be processed electrically. Accordingly, the existence or nonexistence of the specific substance fixed to the movable membrane can be determined and the mass thereof can be also measured in an instant.

Since the two kinds of sensors (i.e., detection sensor and reference sensor) are used, the difference therebetween can be sensed easily and timely, whereby the measurement accuracy can be improved. The oscillating state of the movable membrane can be determined also with the output from the light receiving element in addition to the output from the second piezoelectric membrane. Therefore, even when the signal outputted from the detection electrode contains an error due to the crosstalk or the like, the error can be grasped. As a result, the reliability of the sensed result can be improved.

### BRIEF EXPLANATION OF DRAWINGS

FIG. 1 is an illustrative diagram showing an outline of an embodiment of a physical/chemical sensor.

FIG. 2 is an illustrative diagram showing a front view of the physical/chemical sensor.

FIGS. 3A and 3B are illustrative diagrams showing an end face of a cut section along the III-III line in FIG. 2.

FIGS. 4A and 4B are illustrative diagrams showing an example of a manufacturing method.

FIGS. 5A and 5B are illustrative diagrams showing an example of a manufacturing method.

FIGS. 6A and 6B are illustrative diagrams showing an example of a manufacturing method.

FIG. 7 is an illustrative diagram showing an outline of a sensor used for an experiment.

FIGS. 8A through 8D are SEM photographs of the sensor used for the experiment.

FIGS. 9A and 9B are graphs showing an experimental result.

FIGS. 10A and 10B are graphs showing an experimental result.

### MODES FOR IMPLEMENTING THE INVENTION

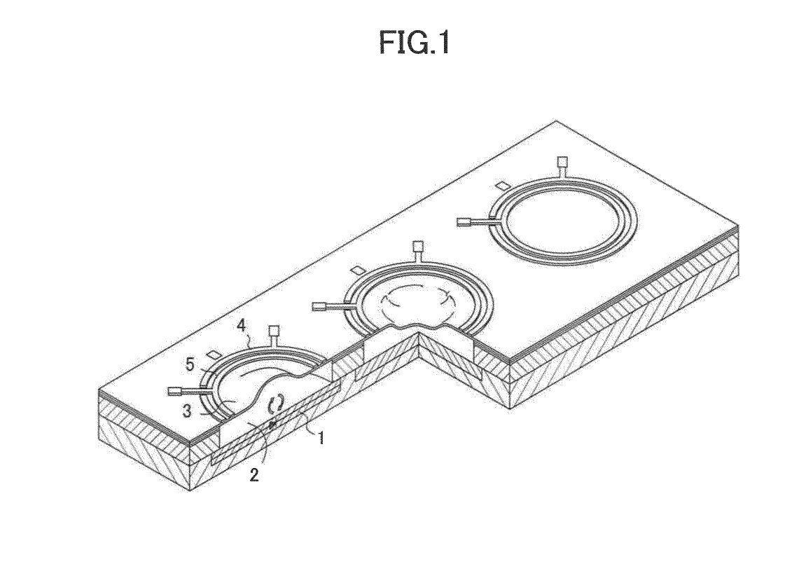

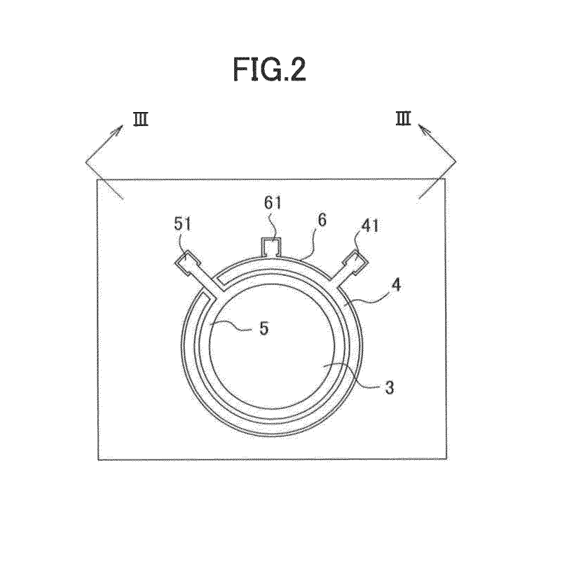

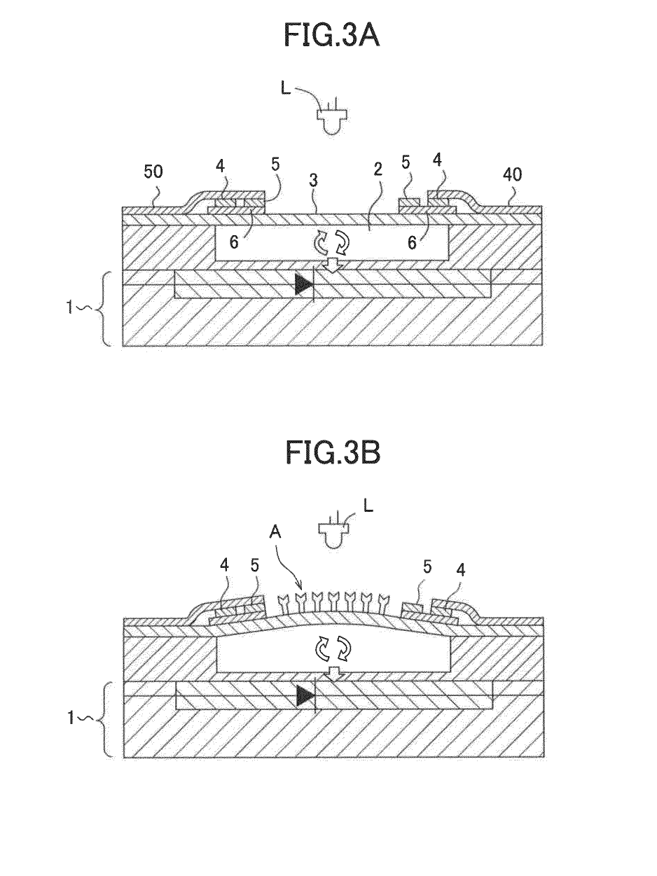

Hereinafter, modes for implementing the present invention will be explained based on the drawings. FIG. 1 is a view showing an outline of an embodiment of the present invention concerning a physical/chemical sensor. FIG. 2 is a front view of the sensor. FIGS. 3A and 3B are view showing an end face of a partly cut section. As shown in these drawings, in the present embodiment, a movable membrane 3 is formed on a light receiving surface of a photodiode (light receiving element) 1 across a hollow section 2. These constitute a Fabry-Perot resonator. A first piezoelectric membrane 4 and a second piezoelectric membrane 5 are laminated on the surface of the movable membrane 3.

The hollow section 2 is formed by partly removing an oxide film laminated on the surface of the photodiode 1. The hollow section 2 has an opening on its upper side, and the movable membrane 3 blocks the opening. In order to form a flexible and thin membrane, a membrane vapor-deposited with parylene C, parylene N or the like is used as the movable membrane 3. Specifically, in order to exert a substance fixation ability on a front-side surface, a material (substance fixing material) having the fixation ability may be laminated on the surface of parylene C or parylene N. When specific substance is protein (antigen), the movable membrane 3 may be constructed to fix a probe molecule (specific antibody) with parylene A or parylene AM. Thus, the protein (antigen) that binds only to the probe molecule (specific antibody) can be detected. The constituent material (membrane section constituent material) constituting the movable membrane 3 is laminated over a wide area including an area lateral to the opening in the upper part of the hollow section 2. An area of the constituent material positioned in the opening part of the hollow section 2 serves as a movable area. The movable area constitutes the movable membrane 3 having a diaphragm structure.

By forming the opening of the hollow section 2 in a substantially round shape, the movable area of the membrane section constituent material can be formed in a substantially round shape. Piezoelectric membranes 4, 5 in the shape of substantially annular belts are laminated near the circumference of the movable area (movable membrane 3). Thus, the movable area (movable membrane 3) can be excited from the circumference, and amplitude during the excitation can be sensed from the entire circumference of the movable area (movable membrane 3). In order to apply a voltage to or in order to output a sensed voltage from the piezoelectric membranes 4, 5, a drive-side electrode is connected to the first piezoelectric membrane 4, and an electrode for output is connected to the second piezoelectric membrane 5, respectively. Further, a base electrode 6 is laminated under the both piezoelectric membranes 4, 5. Although these electrodes are not shown in the drawings clearly, wirings 40, 50 and contacts 41, 51, 61 for connection with an external power supply circuit are provided on a substrate.

In this way, the first and second piezoelectric membranes 4, 5 are laminated near the circumference of the movable membrane 3 having the diaphragm structure. The piezoelectric membranes 4, 5 may be provided on the front side and a backside of the movable membrane 3 respectively or may be provided on the surface of the movable membrane 3 on the same side. When the piezoelectric membranes 4, 5 are provided on the surface on the same side, the second piezoelectric membrane 5 is formed in the position closer to the center of the movable area (movable membrane 3) than the first piezoelectric membrane 4 is. This construction is for sensing the voltage, which is excited by the oscillation of the movable membrane 3, in the position where the oscillation occurs more easily than in the circumference and also for avoiding an overlap between the piezoelectric membranes 4, 5. As mentioned above, the first and second piezoelectric membranes 4, 5 are laminated in the shape of substantially annular belts. The substantially annular shapes of the first and second piezoelectric membranes 4, 5 are coaxial and have different radii from the center of the movable area. The substantially annular shape includes not only a perfect round ring-like shape but also a round ring-like shape that can be considered to have a circular shape. The substantially annular shape includes a continuous annular shape and an annular shape having a discontinuous part. Both of the piezoelectric membranes 4, 5 are formed in the shape of substantially annular belts, but the first piezoelectric membrane 4 lacks a part and is discontinuous for conduction to the second piezoelectric membrane 5. Both of the piezoelectric membranes 4, 5 are made of lead zirconate titanate (PZT). When both of the piezoelectric membranes 4, 5 are formed on the surface on the same side of the movable membrane 3 and the substance fixing material is laminated on the movable membrane 3, the substance fixing material is laminated also on the surfaces of the piezoelectric membranes 4, 5. Therefore, there is a case where the piezoelectric membranes 4, 5 are arranged between the movable membrane 3 and the substance fixing material.

A voltage with frequency that can be changed in a suitable range is applied to the first piezoelectric membrane 4. Frequency and magnitude of the voltage, which is outputted by the second piezoelectric membrane 5, are sensed. The frequency and the magnitude of the voltage outputted by the second piezoelectric membrane 5 correspond to the oscillation of the movable membrane 3. The frequency of the voltage (input voltage) applied to the first piezoelectric membrane 4 is changed to vary the cycle of the oscillation applied to the movable membrane 3, thereby detecting a state (resonance point) where the amplitude (output voltage) is maximized. The frequency of the input voltage at the resonance point is used as resonance frequency. The fixed state of the specific substance to the movable membrane 3 is grasped based on the change of the resonance frequency.

By constituting the movable membrane 3 with a material having light permeability (for instance, above-mentioned parylene), wavelength of light that causes resonance with the Fabry-Perot resonator can be observed. If the movable membrane 3 is constituted with a material that transmits the light (light having specific wavelength), the light receiving surface of the photodiode 1 is irradiated with the light from an outside of the movable membrane 3, and change of intensity of the specific wavelength of the light transmitted through the movable membrane 3 is observed. That is, the movable membrane 3 bends due to an intermolecular force when the specific substance is fixed to the movable membrane 3. Due to the bending, a distance between the light receiving surface of the photodiode 1 and the movable membrane 3 changes. The wavelength of the light that causes resonance with the Fabry-Perot resonator varies in accordance with the change of the distance. By paying attention to the intensity of the light having the specific wavelength, the bending state of the movable membrane 3 can be sensed based on the change of the intensity of the specific wavelength. Thus, the intermolecular force can be sensed by measuring the intensity of the transmitted light with the photodiode.

A half mirror may be constituted by using a metal material for the movable membrane 3. A precious metal (gold, platinum, palladium or the like) having the specific substance fixation ability may be deposited to exert a fixation ability for substance other than the probe molecule (antibody) and to constitute a half mirror. Not only the above-mentioned parylene but also a material having low Young's modulus may be used for the movable membrane 3. Moreover, when the precious metal is deposited, the deposition amount of the precious metal may be small, whereby increase of the Young's modulus and decrease of the light transmittance of the movable membrane 3 can be suppressed. In this way, by constituting the half mirror on the movable membrane 3, selectivity of the wavelength that causes interference inside the Fabry-Perot resonator can be improved. Furthermore, a metal film may be laminated also on the light receiving surface of the light receiving element, thereby improving the effect of the half mirror and narrowing the half width of the interference wavelength.

The present embodiment is constituted as above. Thus, the movable membrane 3 constitutes the Fabry-Perot resonator between the movable membrane 3 and the light receiving surface of the photodiode 1. At the same time, the movable membrane 3 can function as a movable membrane that can oscillate. That is, if the movable membrane 3 fixes the specific substance, the movable membrane 3 can bend and change the intensity of the transmitted light having the specific wavelength. If the movable membrane 3 is excited at predetermined frequency, the movable membrane 3 can oscillate according to the frequency.

Therefore, the state of the oscillation of the movable membrane 3 is outputted as the voltage through the second piezoelectric membrane 5. The intensity of the light transmitted through the movable membrane 3 can be outputted electrically as a photocurrent. By analyzing the both outputs, the intermolecular force of the substance, which can be fixed to the movable membrane 3, can be measured, and the mass of the substance can be measured.

The intensity of the transmitted light having the specific wavelength can be sensed also in the state where the movable membrane 3 oscillates. Therefore, the oscillating state of the movable membrane 3 may be sensed also by the change of the intensity of the transmitted light. In this way, the change of the voltage sensed from the detection electrode 5 and the change of the intensity of the transmitted light may be sensed at the same time. Thus, the amplitude can be measured based on the output of the detection electrode while checking the oscillation of the movable membrane 3 based on the intensity of the transmitted light.

The movable membrane 3 of the present embodiment is formed in the shape of the diaphragm structure. Therefore, the hollow section 2 can be blocked with the movable membrane 3 liquid-tightly or air-tightly. Accordingly, permeation of a specimen into the hollow section 2 can be avoided. In addition, since the backside surface of the movable membrane 3 exists only inside the hollow section 2, adsorption of the specimen (and contained specific substance) to the backside surface of the movable membrane 3 can be avoided.

Next, an outline of a manufacturing method of the above embodiment will be explained. The above embodiment can be manufactured mainly with semiconductor process technology. Constituent parts can be manufactured in the size of nanometers or micrometers, whereby a very small sensor can be manufactured. The construction of the above embodiment is made by laminating the piezoelectric membranes 4, 5 on the surface of the movable membrane 3 that constitutes the Fabry-Perot resonator. Therefore, the Fabry-Perot resonator is manufactured first, and then laminating process of the piezoelectric membranes 4, 5 is performed. The manufacturing method of the Fabry-Perot resonator is described in detail in Patent document 1 mentioned above. There is a method of forming a sacrifice layer under the movable membrane 3 and etching the sacrifice layer. There is also a method of pasting the layers.

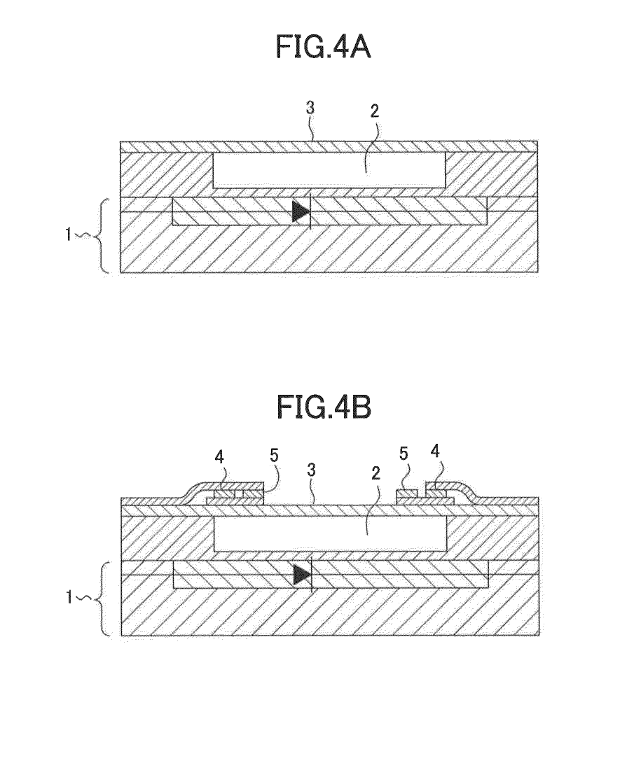

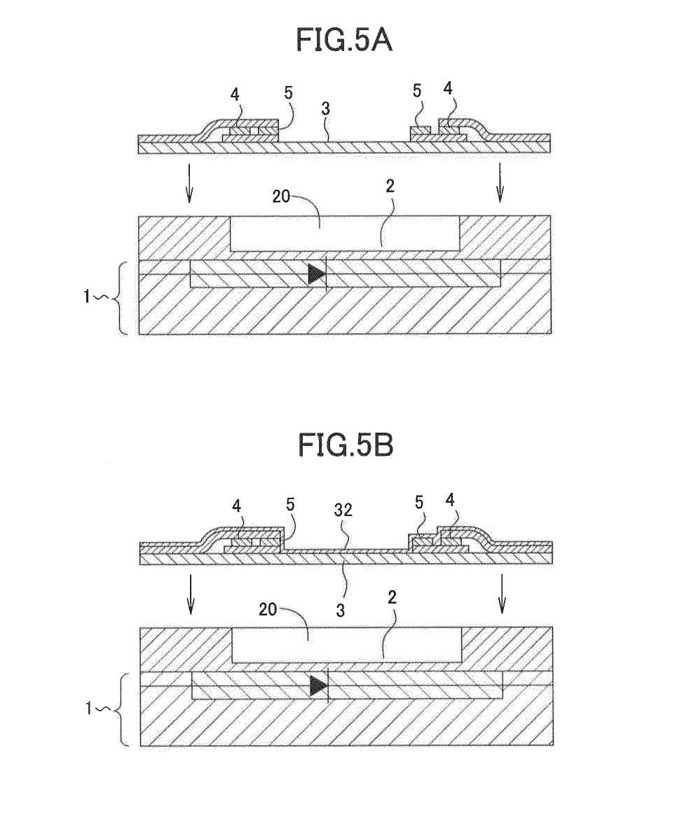

FIGS. 4A, 4B, 5A and 5B are diagrams showing an outline of manufacturing steps. As shown in the diagrams, the movable membrane 3 has been already formed in the state where the Fabry-Perot resonator is manufactured (refer to FIG. 4A). The base electrode is formed on the movable membrane 3, and the piezoelectric membranes 4, 5 are laminated. As shown in FIG. 4B, if the movable membrane 3 is made of a material having the substance fixation ability; the piezoelectric membranes 4, 5 are laminated on the surface of the movable membrane 3. When PZT is used as the material of the piezoelectric membranes 4, 5, PZT can be laminated by a sputtering method or a sol-gel method. If the movable membrane 3 does not have the substance fixation ability, a substance fixing material may be laminated on the surface of the movable membrane 3 first, and then the piezoelectric membranes 4, 5 may be laminated. Alternatively, the piezoelectric membranes 4, 5 may be laminated first, and then the entirety may be covered with the substance fixing material.

Alternatively, as shown in FIG. 5A, the photodiode 1 may be formed and a predetermined gap 20 may be formed in the light receiving surface first, and then the movable membrane 3 may be pasted. In this case, the piezoelectric membranes 4, 5 are laminated on the movable membrane 3 before pasting the movable membrane 3. Also in this case, when the movable membrane 3 has the substance fixation ability, PZT may be laminated on the front-side surface or the backside surface of the movable membrane 3 (front-side surface in the case shown in diagram) beforehand by the sputtering method or the sol-gel method. When the movable membrane 3 does not have the substance fixation ability, the substance fixing material may be laminated after laminating PZT.

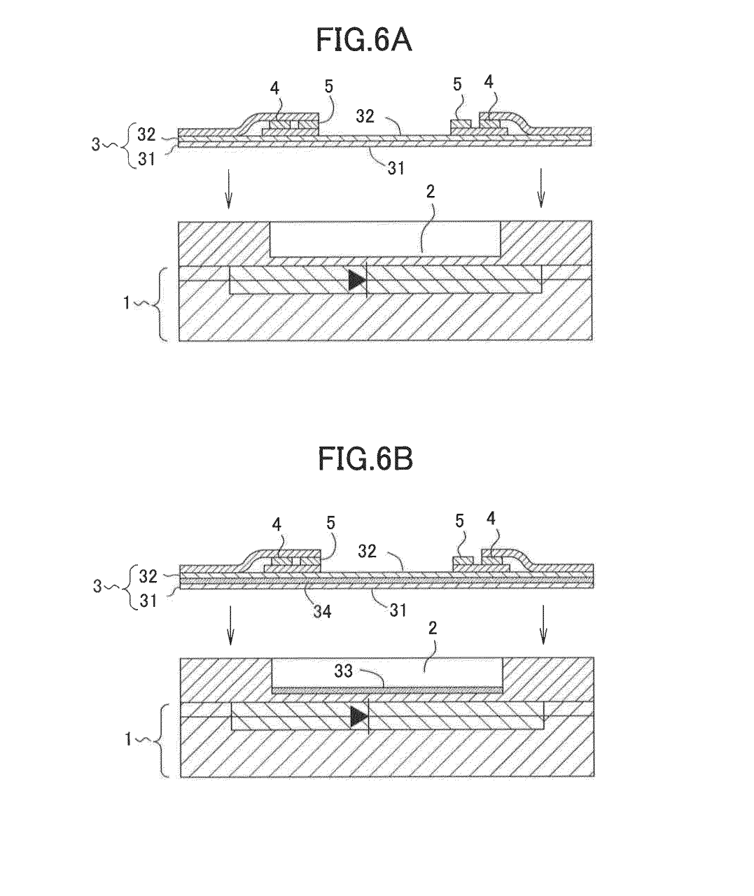

When the movable membrane 3 does not have the substance fixation ability, as shown in FIG. 6A, a membrane (substance fixation membrane 32) made of a substance fixing material may be laminated on the movable membrane 3 (base membrane 31), and the piezoelectric membranes 4, 5 may be laminated thereon. Then, the movable membrane 3 may be pasted. In this case, the base membrane 31 and the substance fixation membrane 32 are integrated and can function as the movable membrane 3. When the Fabry-Perot resonator is provided with a half mirror, as show in FIG. 6B, a metal film 33 may be laminated on the light receiving surface of the photodiode 1, and a metal film 34 may be laminated in the movable membrane 3 (between base membrane 31 and substance fixation membrane 32). Then, the movable membrane 3 and the photodiode 1 may be pasted together.

Parylene C, parylene N or the like can be used as the base membrane 31. Parylene A, parylene AM or the like can be used as the substance fixation membrane 32. The concept of the substance fixation membrane 32 is a wide concept and includes a molecule fixation membrane. When parylene A or parylene AM is used, antibody molecules or the like can be fixed.

Next, a measuring method of the specific substance using the physical/chemical sensor described as the above embodiment will be explained. Although the physical/chemical sensor used here (hereafter, also referred to simply as sensor) has the construction described as the above embodiment, the sensor may be modified in various ways. There is also a case where integrated sensors are used.

A first measuring method is performed in following steps. (1) In order to sense an initial value of the sensor, intensity of the transmitted light is sensed in a state before a specimen is supplied. (2) In order to sense the resonance frequency of the movable membrane in the state before the specimen is supplied, a voltage is applied to the first piezoelectric membrane while changing the frequency, and the frequency with the highest voltage is sensed with the output from the second piezoelectric membrane. (3) The specimen is supplied to the surface of the movable membrane of the sensor, and the intensity of the transmitted light is measured. If the intensity of the transmitted light changes at that time, it is determined that the specific substance is fixed. If there is no change in the intensity of the transmitted light, it is determined that no specific substance exists in the specimen. (4) If it is determined that the specific substance is fixed, excitation is performed again while changing the frequency, and the resonance frequency is sensed. At that time, the mass is calculated according to the change of the resonance frequency. The mass is calculated based on the change in the resonance frequency with reference to examples of resonance frequency of conventional cantilevers. Alternatively, specific relationships of the sensor having the construction of the above embodiment may be obtained statistically, and the mass may be calculated from statistic values.

With the measuring method based on the above procedure, whether the specific substance is fixed or not can be clearly grasped based on the change of the intensity of the transmitted light using the Fabry-Perot resonator. Moreover, the mass of the fixed specific substance is calculated based on the frequency, at which the oscillation of the movable membrane coincides with the resonance point. Accordingly, existence or nonexistence of the specific substance can be determined and the mass of the specific substance can be measured with one supply of the specimen. In addition, the intermolecular force of the fixed substance can be measured based on the above-mentioned intensity of the transmitted light. Therefore, the kind and the state of the fixed substance and the like can be also determined based on the relationship between the intermolecular force and the mass. Specifically, when the intermolecular force differs although the mass is the same, it can be also determined that the fixed substance has changed (altered).

When the substance fixation ability used for the movable membrane (or provided by laminated substance fixation membrane) is limited to the ability for fixing specific substance, the substance fixation ability enables measurement of the specific substance. Furthermore, in the label-free test in the medical field, for instance, parylene A or parylene AM may be used as the material having the substance fixation ability, and a specific antibody (probe molecule) may be fixed. Thus, a specific antigen (protein), which binds to the antibody, can be detected. By changing the kind of the antibody suitably, fixation of a specific antigen that binds to the antibody can be grasped. In this measuring method, when the initial value of the sensor is sensed, it is necessary to fix the antibody to the surface of the movable membrane in advance. By integrating multiple sensors and by fixing different antibodies thereto individually in advance, multiple antigens can be detected and measured by one supply of the specimen.

As another measuring method, multiple sensors may be used and classified into a detection sensor (or detection sensors) and a reference sensor (or reference sensors), and the specimen may be supplied only to the detection sensor(s). Sensors manufactured under the same conditions are used for the detection sensor(s) and the reference sensor(s). In this case, the method is performed in following steps. (1) The specimen is supplied only to the detection sensor(s). (2) The intensity of the transmitted light is measured with both of the detection sensor(s) and the reference sensor(s). It is determined whether the specific substance is fixed based on the difference therebetween. (3) When the specific substance is fixed, the movable membranes of the both sensors are excited and the difference between the resonance frequencies thereof is sensed. (4) The mass is calculated by conversion of the difference in the resonance frequencies at that time.

With the above procedure, it is unnecessary to sense the initial value of the sensor each time. Therefore, the detection and the measurement of the specific substance can be performed in a short time. Also in the above procedure, in order to sense the resonance frequency of the movable membrane, the frequency of the voltage applied to the first piezoelectric membrane is changed, and the frequency, at which the voltage outputted from the second piezoelectric membrane is maximum, is used as the resonance frequency.

When the multiple sensors are classified into the detection sensor(s) and the reference sensor(s), a single reference sensor and multiple detection sensors may be provided such that the sensing values of the respective detection sensors can be compared with the single reference sensor. Alternatively, the same numbers of both sensors may be prepared, and comparison may be performed on one-to-one basis. For instance, in the label-free test in the medical field, there is a method of fixing a specific antibody to the movable membrane of the detection sensor beforehand and of detecting fixation of an antigen that binds to the antibody. Therefore, the state of the antibody fixed before the test is uniformed between the detection sensor and the reference sensor. When the kinds of the antibodies fixed in advance are different from each other, the intermolecular forces and the masses can be different among them. Therefore, the sensing result of the detection sensor is related with the reference sensor to be compared on one-to-one basis. Also in this case, the multiple sensors may be integrated, and multiple data may be sensed at the same time.

The embodiment of the measuring method according to the present invention is as above. In addition to the above measuring methods, a measuring method of sensing the intensity of the transmitted light during the excitation of the movable membrane may be also employed. The intensity of the transmitted light is sensed mainly for measuring the intermolecular force as mentioned above. Regarding the deformation of the movable membrane due to the oscillation, when the frequency changes, the intensity of the transmitted light changing with the deformation (bending) can be sensed. Therefore, by sensing the intensity of the transmitted light at the same time when detecting the resonance point of the movable membrane, the amplitude of the oscillation (i.e., amount of change of bending) can be also sensed. Therefore, the state where the amplitude is maximum may be determined to be the resonance point of the movable membrane. However, there is a case where the difference in the change of the amplitude cannot be grasped clearly. Therefore, the sensed value of the intensity of the transmitted light is used as an auxiliary reference or is used for confirmation. Specifically, supposing a case where a certain voltage value is outputted from the second piezoelectric membrane due to crosstalk or the like, it is effective to use the sensed value as supportive data for determining that the voltage value outputted from the second piezoelectric membrane is caused by the oscillation.

The embodiments of the present invention are as above but the present invention is not limited to the above embodiments. For instance, in the above description of the embodiments of the sensor, the sensor having the first and second piezoelectric membranes 4, 5 provided only on the front-side surface of the movable membrane 3 is illustrated. Even with the construction that the first and second piezoelectric membranes 4, 5 are provided on the backside surface, it is expected that similar effects are exerted. Moreover, the first piezoelectric membrane and the second piezoelectric membrane may be provided on the front-side surface and on the backside surface of the movable membrane respectively. In this case, the base electrodes are provided on the front-side surface and the backside surface of the movable membrane respectively, and a possibility of occurrence of the crosstalk can be reduced. In the above embodiments, the photodiode is used as the example of the light receiving element, but other light receiving element may be used.

### EXPERIMENT EXAMPLE

As an experiment, the movable membrane was excited with the first piezoelectric membrane, and it was determined whether the oscillation can be detected with the second piezoelectric membrane. Next, an example of the experiment will be explained.

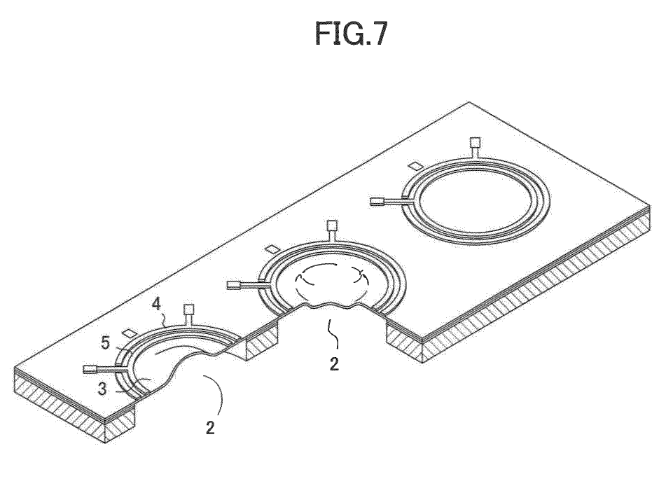

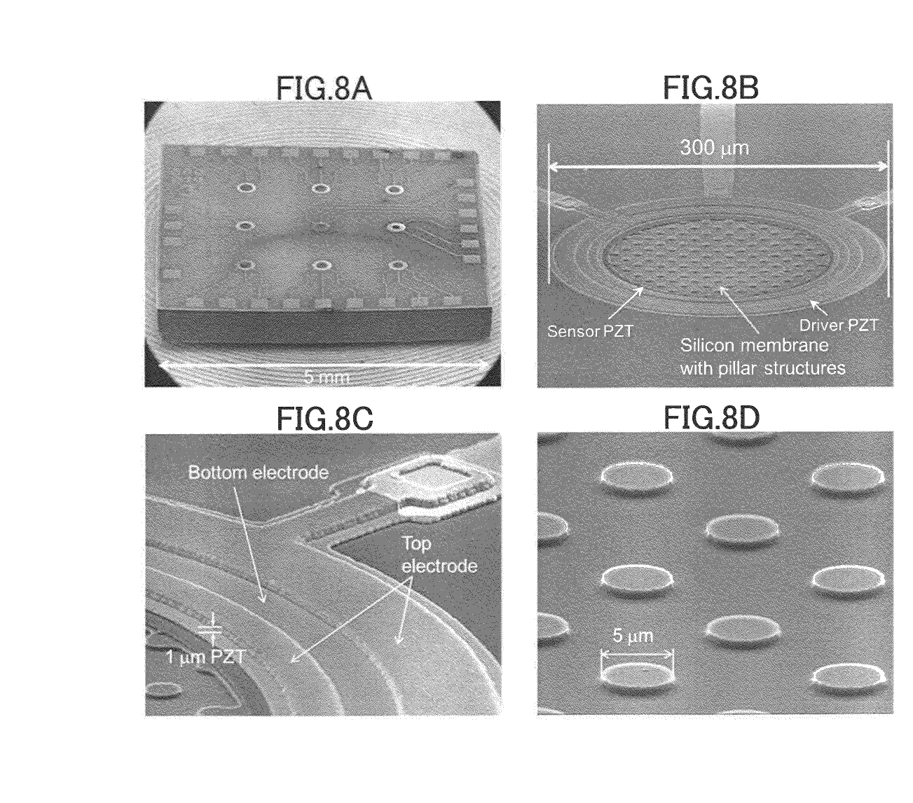

The sensor used for the experiment was prepared by etching a surface of a silicon substrate such that the hollow section is formed. The remaining silicon in the shape of a thin film was used as the movable membrane. A common base electrode was laminated on the circumference of the movable membrane. Further, two kinds of PZT in the shape of substantially annular belts with the thickness of 1 micrometer each were laminated coaxially on the surface of the base electrode. The outer PZT was used as driver PZT and the inner PZT was used as sensor PZT. A voltage was applied to the driver PZT while changing the frequency, and a voltage outputted from the sensor PZT was measured. In order to increase the surface area of the movable membrane, half etching was applied to the surface of the movable membrane. Thus, multiple protrusions in the shape of substantially circular columns (pillars) were formed on the surface. An outline is shown in FIG. 7 and a SEM photograph is shown in FIGS. 8A-8D. In this example, the movable membrane for sensing the frequency of the oscillation is formed. Therefore, a photodiode and an accompanying Fabry-Perot resonator are not manufactured. Sensing of the bending of the membrane section (intermolecular force) using the Fabry-Perot resonator has been already described in Patent document 1 mentioned above.

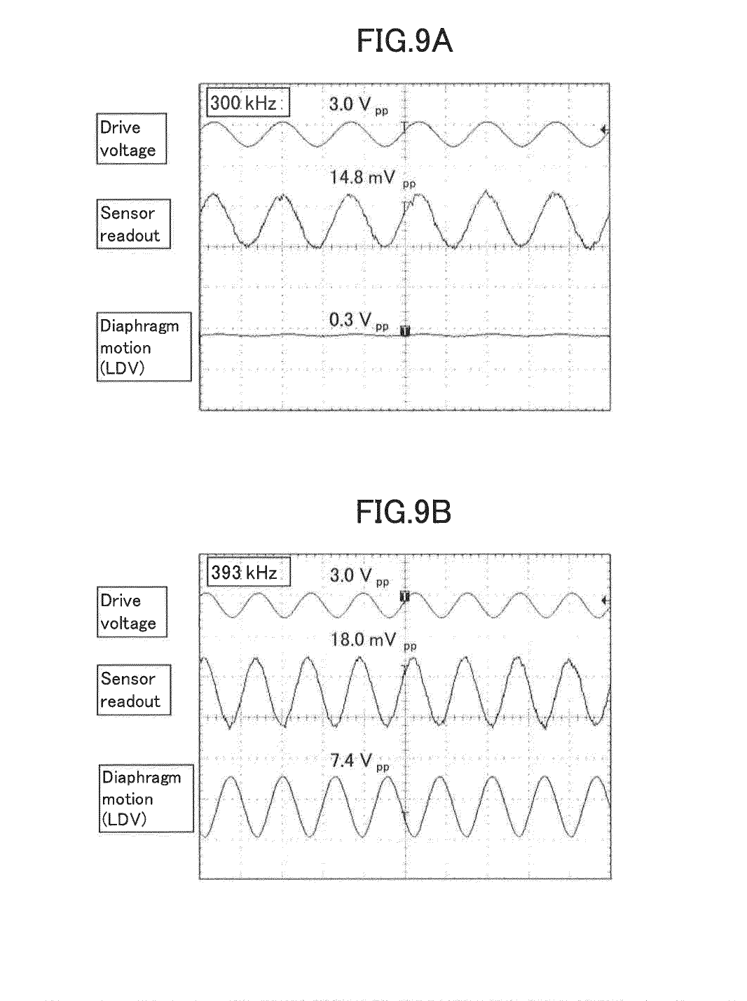

By using the sensor for the above-mentioned experiment, a voltage at low frequency was applied to the driver PZT, and the frequency was increased gradually as an experiment. As a result, the movable membrane did not resonate when the voltage of 300 kHz was applied but resonated when the voltage of 393 kHz was applied. Relationships between the input frequency and the sensed voltage at that time are shown in FIGS. 9A and 9B. FIG. 9A shows the case at the time when the resonance does not occur and FIG. 9B shows the case at the time when the resonance occurs. In addition, a graph of an output of a Doppler vibrometer (indicated as “Diaphragm motion (LDV)”) is shown in each of FIGS. 9A and 9B for reference. As is obvious from the experimental result, the output voltage at the time when the resonance occurs is larger than the output voltage at the time when the resonance does not occur. This shows that the amplitude of the movable membrane increases, and the resonance point can be grasped. In this experimental result, the voltage is outputted when the resonance does not occur differently from the output of the Doppler vibrometer. This is thought to be caused by the crosstalk.

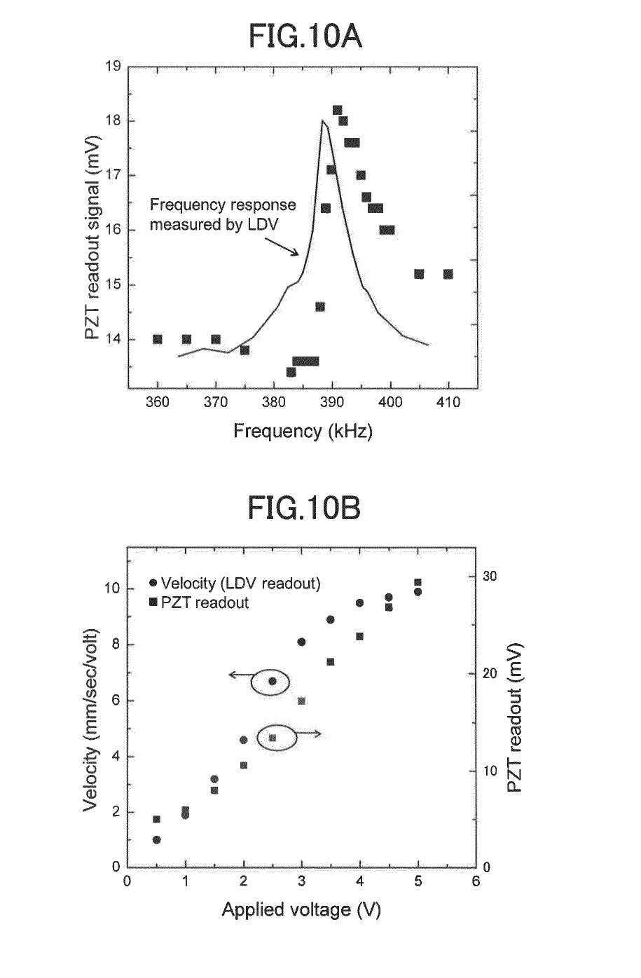

Displacement of the movable membrane (i.e., measurement value of Doppler vibrometer) and change of the voltage measured with the sensor PZT are shown in FIG. 10A. Relationships among the magnitude of the voltage applied to the driver PZT, the amplitude of the movable membrane (i.e., measurement value of Doppler vibrometer) and the voltage value outputted from the sensor PZT are shown in FIG. 10B. As is obvious from these results, the measurement value of the Doppler vibrometer and the voltage value outputted from the sensor PZT are similar to each other. Therefore, the state of the oscillation of the movable membrane can be grasped from the voltage value outputted from the sensor PZT. In addition, the amplitude of the movable membrane can be adjusted by changing the magnitude of the voltage applied to the driver PZT.

Thus, by detecting the resonance point of the movable membrane, which is oscillated with the driver PZT, using the sensor PZT, and by sensing the frequency at the time of the resonance, the mass measurement with the fixation membrane can be performed.

In the above-explained embodiments, PZT is used as the material of the piezoelectric membrane. Alternatively, a perovskite ferroelectric material such as lead niobium zirconate titanate (PNZT), which is doped with Nb, a lead-free piezoelectric material such as aluminum nitride (AlN), a polymeric piezoelectric material (such as PVDF (polyvinylidene fluoride) and polybutyric acid) and the like can be used.

### EXPLANATION OF MARKS

1 Photodiode (light receiving element)
2 Hollow section
3 Movable membrane
4 First piezoelectric membrane
5 Second piezoelectric membrane
A Antibody
L Light source
31 Base membrane
32 Substance fixation membrane

1. A physical/chemical sensor comprising:
a movable membrane having a diaphragm structure provided to form a hollow section between the movable membrane and a light receiving surface of a light receiving element;
a first piezoelectric membrane that is provided on a front-side surface or a backside surface of the movable membrane and that excites the movable membrane; and
a second piezoelectric membrane that is provided on the front-side surface or the backside surface of the movable membrane and that senses a voltage caused by oscillation of the movable membrane, wherein
the movable membrane has a substance fixation ability at least on an outside surface thereof and forms a Fabry-Perot resonator with the light receiving surface.

2. The physical/chemical sensor as in claim 1, wherein
the hollow section has an opening in a predetermined area that faces the light receiving surface of the light receiving element, and
the movable membrane is formed to block the opening of the hollow section.

3. The physical/chemical sensor as in claim 2, wherein
the opening of the hollow section has a substantially round shape,
the movable membrane blocks the opening of the hollow section and is formed as a diaphragm structure in a substantially round shape,
the first and second piezoelectric membranes are formed in the shape of substantially annular belts coaxial around the center of the movable membrane, and
the first and second piezoelectric membranes are arranged on the center side of an edge of the opening of the hollow section.

4. The physical/chemical sensor as in claim 3, wherein
the first and second piezoelectric membranes are arranged on either the front-side surface or the backside surface of the movable membrane, and
the second piezoelectric membrane is arranged to be nearer to the center of the movable membrane than the first piezoelectric membrane is such that a gap is provided between the first and second piezoelectric membranes.

5. The physical/chemical sensor as in claim 1, wherein
the movable membrane is made of a material that has a molecule fixation ability to fix molecules contained in a gas or a liquid.

6. The physical/chemical sensor as in claim 1, wherein
the movable membrane has a flexible base membrane and has a molecule fixation membrane, which is formed by laminating a material having a molecule fixation ability on a surface of the base membrane.

7. The physical/chemical sensor as in claim 1, wherein
the first and second piezoelectric membranes are made of lead zirconate titanate (PZT).

8. The physical/chemical sensor as in claim 1, wherein
the surface of the movable membrane is uneven.

9. A measuring method of specific substance using the physical/chemical sensor as in any one of claims 1 to 8, the method comprising the steps of:
changing frequency of a voltage applied to the first piezoelectric membrane to change frequency of oscillation of the movable membrane;
sensing resonance frequency at the time of the oscillation of the movable membrane based on a voltage outputted from the second piezoelectric membrane; and
converting a change amount of the resonance frequency into mass of the specific substance fixed to the movable membrane.

10. The measuring method of the specific substance as in claim 9, further comprising the steps of:
illuminating the light receiving surface of the light receiving element with light in a state where a voltage is applied to the first piezoelectric membrane;
measuring change of intensity of transmitted light having specific wavelength as a photocurrent; and
estimating the resonance frequency at the time of the oscillation of the movable membrane according to the change of the intensity of the transmitted light.

11. A measuring method of specific substance using the physical/chemical sensor as in any one of claims 1 to 8, the method comprising the steps of:
forming a plurality of the physical/chemical sensors under the same conditions;
classifying the physical/chemical sensors into at least one detection sensor and at least one reference sensor;
supplying gaseous specimen or liquid specimen containing certain substance as a measurement object only to the at least one detection sensor, wherein the movable membrane has the fixation ability to fix the certain substance;
changing frequency of a voltage applied to the first piezoelectric membranes of the at least one detection sensor and the at least one reference sensor to change frequencies of oscillation of the movable membranes simultaneously;
sensing resonance frequencies at the time of the oscillation of the movable membranes based on voltages outputted from the second piezoelectric membranes; and
comparing the resonance frequencies of the at least one detection sensor and the at least one reference sensor to convert a difference between the resonance frequencies into mass of the specific substance.

12. The measuring method of the specific substance as in claim 11, further comprising the steps of:
illuminating the light receiving surface of the light receiving element with light in a state where a voltage is applied to the first piezoelectric membrane;
measuring change of intensity of transmitted light having specific wavelength as a photocurrent; and
estimating the resonance frequency at the time of the oscillation of the movable membrane according to the change of the intensity of the transmitted light.
